(19) United States
(12) Patent Application Publication
(10) Pub. No.: US 2026/0050269 A1
(43) Pub. Date: Feb. 19, 2026

(54) METHODS AND APPARATUS FOR DRONE INTERACTION WITH MOVING PLATFORM

(71) Applicant: Nova Sky Stories LLC, Boulder, CO (US)

(72) Inventors: Tobias Gurdan, Germering (DE); Daniel Gurdan, Germering (DE)

(21) Appl. No.: 18/807,080

(22) Filed: Aug. 16, 2024

(51) Int. Cl. G05D 1/654; G01S 5/02; G05D 1/646; G05D 1/652; G05D 1/69; G05D 109/20; G05D 111/30

(52) U.S. Cl. CPC G05D 1/6542; G01S 5/0294; G05D 1/646; G05D 1/652; G05D 1/69; G05D 2109/20; G05D 2111/30

(57) ABSTRACT

Methods and apparatus to create and perform drone displays are disclosed. An example drone display may include one or more drones that launch from a movable platform, land on a movable platform, or both. The drone display may follow the movable platform to provide a display to an audience that is moving with the movable platform, or that is stationary and watching as one or more movable platforms travel through an area.

### CROSS-REFERENCE TO RELATED APPLICATIONS

This application claims priority to U.S. Provisional Patent Application No. 63/520,579, filed on Aug. 18, 2023, entitled “METHODS AND APPARATUS FOR DRONE INTERACTION WITH MOVING PLATFORM,” the disclosure of which is incorporated by reference herein in its entirety.

### FIELD OF TECHNOLOGY

This disclosure relates generally to drones, and, more particularly, to methods and apparatus to provide drone interaction with a moving platform, such as for creating drone displays that move along with, launch, and/or land from a moving platform.

### BACKGROUND

In recent years, unmanned aerial vehicles (UAVs) (e.g., drones) have become available as commercial and recreational devices.

### BRIEF DESCRIPTION OF THE DRAWINGS

FIG. 1 shows an example of a drone or UAV that supports drone interaction with a moving platform in accordance with various aspects of the disclosure.

FIG. 2 shows an example of a drone display system and drone display that interacts with a moving platform in accordance with various aspects of the disclosure.

FIG. 3 shows an example of a method that supports drone interaction with a moving platform in accordance with various aspects of the disclosure.

FIG. 4 shows an example of another method that supports drone interaction with a moving platform in accordance with various aspects of the disclosure.

FIG. 5 shows a block diagram of an example processor platform that supports drone interaction with a moving platform in accordance with various aspects of the disclosure.

### DETAILED DESCRIPTION

Presenting displays to audiences (e.g., at a concert, in a stadium, at an outdoor venue, in an indoor venue, at an outdoor aquatic event, at a race, etc.) can be challenging. For example, in established venues, physical screens may be installed, which are directed toward certain viewing areas, and may be visible to all or a subset of the audience. However, such displays are limited in size to the physical screens, and to the location(s) of the physical screens. Further, in many instances displays are desired to be provided in areas that simply do not have physical screens present or may not be amenable to a temporary or permanent installation of such screens. To overcome these challenges, a fleet of choreographed, flying, light-emitting unmanned aerial vehicles (UAVs), also referred to as drones, can be used to create drone displays (e.g., a static and/or moving virtual displays in the air). In some examples, a display may be partially or wholly formed by drones. Drone displays can be tilted, curved, spherical, two-dimensional (2D), three-dimensional (3D), geometric, non-geometric, animated, or any combinations thereof. In some examples, drone displays are easily viewed, easily customizable, and may be reusable for multiple events.

In some examples, drone displays have configurable resolutions, are dynamically locatable (e.g., movable between various positions), are arbitrarily shaped (e.g., geometric, non-geometric, etc.), are dynamically shaped (e.g., a shape that is morphing, changing, etc.), and/or are dynamically sizable. Compared to conventional physical screens, some drone displays can be dynamic entities that can move, change and/or be part of a presented show. In accordance with some aspects as discussed herein, the location, configuration, or both, of an audience can be tracked or known a priori and used to adapt a drone display. A non-limiting example of a drone display has a shape (e.g., a hemisphere, a dome, a cone, etc.) of drones flying above a moving platform to provide a display to an audience associated with the moving platform. In some aspects, a set of drones may launch, land, or both, from the moving platform. For example, a flock of drones may launch from the moving platform, land on the moving platform, launch from a stationary platform, land on the stationary, launch from a different moving platform, land on the different moving platform, or any combinations thereof.

In some aspects, provide visibility of drone displays to an audience associated with a moving platform (e.g., an audience located on the moving platform or an audience that the moving platform moves past), examples disclosed herein can, among other aspects, provide displays that automatically move in accordance with the moving platform, automatically optimize a viewing angle of the display relative to the audience based on platform movement and a relative location of the audience, or any combinations thereof. That is, disclosed examples provide one or more of launch and/or landing of a set of drones on the moving platform, provide for the dynamic movement of content in accordance with platform movement to form a 2D or 3D drone display, and can adapt the drone displays as an audience moves. Most known content mapping solutions are limited to the mapping of content onto 2D displays.

Reference will now be made in detail to non-limiting examples, some of which are illustrated in the accompanying drawings.

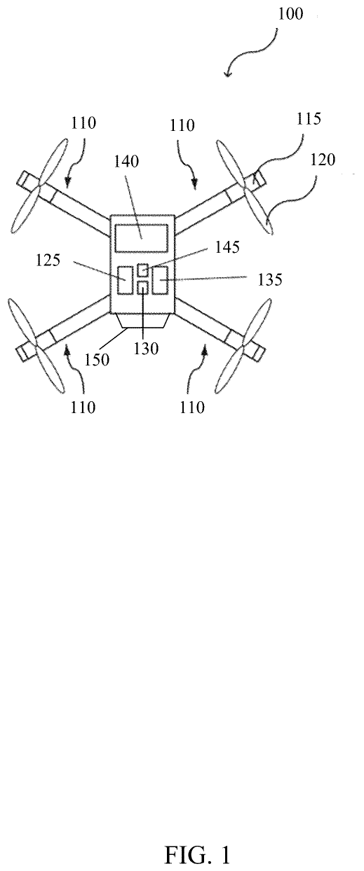

FIG. 1 illustrates an UAV 100 in a schematic view, according to various aspects. The UAV 100 may include a plurality of (e.g., three or more than three, e.g., four, six, eight, etc.) vehicle drive arrangements 110. Each of the vehicle drive arrangements 110 may include at least one drive motor 115 and at least one propeller 120 coupled to the at least one drive motor 115. The one or more drive motors 115 of the UAV 100 may be electric drive motors.

Further, the UAV 100 may include one or more processors 125 configured to control flight or any other operation of the UAV 100 including but not limited to navigation, image analysis, location calculation, and any method or action described herein. One or more of the processors 125 may be part of a flight controller or may implement a flight controller. The one or more processors 125 may be configured, for example, to provide a flight path based at least on an actual position of the UAV 100 and a desired target position for the UAV 100. In some aspects, the one or more processors 125 may control the UAV 100. In some aspects, the one or more processors 125 may directly control the drive motors 115 of the UAV 100, so that in this case no additional motor controller may be used. Alternatively, the one or more processors 125 may control the drive motors 115 of the UAV 100 via one or more additional motor controllers. The one or more processors 125 may include or may implement any type of controller suitable for controlling the desired functions of the UAV 100. The one or more processors 125 may be implemented by any kind of one or more logic circuits.

According to various aspects, the UAV 100 may include one or more memories 130. The one or more memories may be implemented by any kind of one or more electronic storing entities, e.g. a one or more volatile memories and/or one or more non-volatile memories. The one or more memories 130 may be used, e.g., in interaction with the one or more processors 125, to build and/or store image data, ideal locations, locational calculations, or alignment instructions.

Further, the UAV 100 may include one or more power supplies 135. The one or more power supplies 135 may include any suitable type of power supply, e.g., a directed current (DC) power supply. A DC power supply may include one or more batteries (e.g., one or more rechargeable batteries), etc.

According to various aspects, the UAV 100 may include one or more sensors 140. The one or more sensors 140 may be configured to monitor a vicinity of the UAV 100. For example, the one or more sensors 140 may be configured to detect obstacles in the vicinity of the UAV 100. The one or more sensors 140 may include, for example, one or more cameras (e.g., a depth camera, a stereo camera, a thermal imaging camera, etc.), one or more ultrasonic sensors, etc. The UAV 100 may further include a position detection system 145. The position detection system 145 may be based, for example, on a global navigation satellite system (GNSS), such as Global Positioning System (GPS) or any other available positioning system (e.g., terrestrial and/or satellite-based positioning systems). Therefore, the one or more processors 125 may be further configured to modify the flight path of the UAV 100 based on data obtained from the position detection system 145. As discussed in more detail herein, in some aspects the one or more processors 125 may be further configured to modify the flight path of the UAV 100 based on movement of a moving platform associated with the UAV 100. The sensors 140 may be mounted as depicted herein, or in any other configuration suitable for an implementation. One or more light elements 150 (e.g., LED light modules, laser light modules, etc.) may be mounted to the UAV 100 and may be selectively illuminated as part of a display formed from multiple UAVs 100.

According to various aspects, at least one of the one or more processors 125 may include at least one transceiver configured to provide an uplink transmission and/or downlink reception of radio signals including data (e.g. video or image data and/or commands, platform position information, etc.). The at least one transceiver may include a radio frequency (RF) transmitter and/or a radio frequency (RF) receiver.

In some aspects, the one or more processors 125 may further include an inertial measurement unit (IMU) and/or a compass unit. The inertial measurement unit may allow, for example, a calibration of the UAV 100 regarding a predefined plane in a coordinate system, e.g., to determine the roll and pitch angle of the UAV 100 with respect to the gravity vector (e.g. from planet earth). Thus, an orientation of the UAV 100 in a coordinate system may be determined. The orientation of the UAV 100 may be calibrated using the inertial measurement unit before the UAV 100 is operated in flight modus. However, any other suitable function for navigation of the UAV 100, e.g., for determining a position, a flight velocity, a flight direction, etc., may be implemented in the one or more processors 125 and/or in additional components coupled to the one or more processors 125.

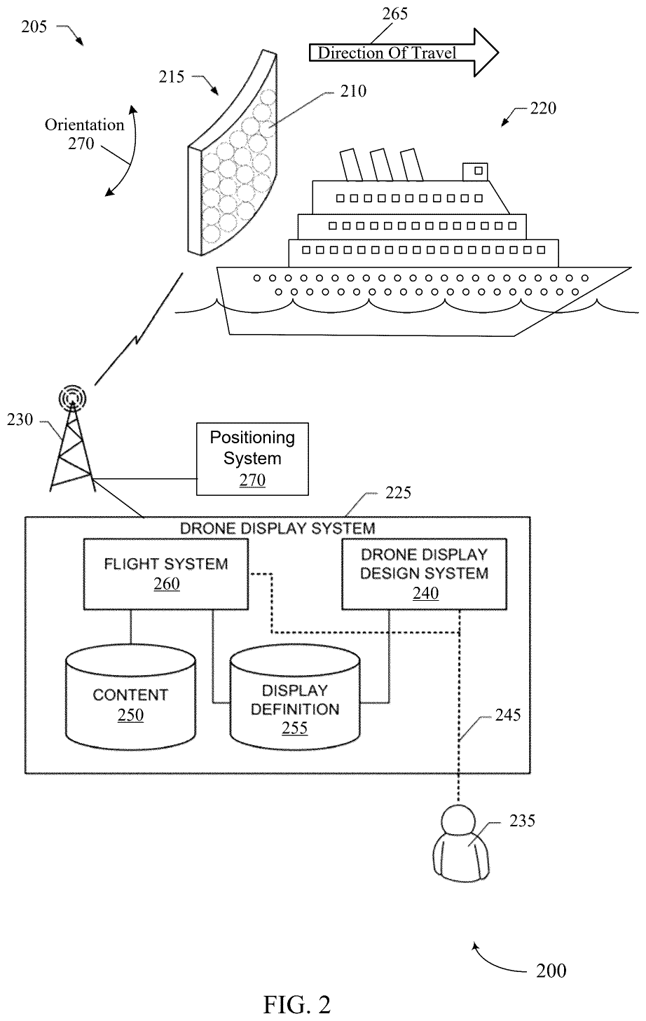

FIG. 2 illustrates an example drone display system 200 in accordance with various aspects of this disclosure, and shown in an example environment of use 205. The example drone display system 200 of FIG. 2 controls any number and/or type(s) of UAVs (e.g., drones 210) to form an example drone display 215 on which content is displayed. In some examples, the drones 210 are colored, illuminated, reflective, shaped, etc. in one or more directions to form the example drone display 215. In some examples, a drone 210 can display assorted colors in different directions. The example drone display 215 is shaped, sized, positioned, etc. to be viewed by an audience on a movable platform 220 such as a cruise ship in the example of FIG. 2. It is to be understood that numerous other examples of moving platforms may be associated with a drone display 215, such as one or more vehicles in a parade or procession, moving vehicles advertising a product or service, other moving watercraft, or one or more individuals moving around an area, to name just a few examples. In the illustrated example of FIG. 2, a drone display system 225 controls the drones 210 and the drone display 215 via a communications station 230 (e.g., a cellular radio head, a wireless access point (AP), a wireless hotspot, etc.). Additionally, or alternatively, the drones 210 may be programmed by the drone display system 225, including any applicable safety precautions, and flown autonomously.

To enable a user 235 to design one or more aspects of the example drone display 215, the example drone display system 225 of FIG. 2 may include a drone display design system 240. In some examples, the drone display design system 240 may include a collection of standalone applications, a collection of integrated applications, etc. accessed via, for example, a user interface. In some examples, the applications are web-based applications integrated to form a web-based drone design display portal. In some examples, the applications are standalone applications integrated to present the appearance of an integrated solution. The user 235 via, for example, the user interface of the example drone display design system 240 of FIG. 2, may provide input(s) 245 that represent the configuration of the audience. Example inputs 245 include, but are not limited to, an arrangement of audience member viewing area(s) (e.g., a length and width of a viewing area, elevation changes of the viewing area), a number of rows arranged on an upwardly sloped audience stand, different elevations of different viewing areas, or any combinations thereof. Example inputs may, additionally, or alternatively, include design constraints or desired aspects of the drone display 215 such as, shaped (e.g., curved as shown in FIG. 2), one-sided or more than one sides, viewing angle (e.g., an audience member doesn't have to look upward by more than N feet, or M feet left or right), etc. In some examples, some such inputs 245 are selected from a plurality of options or examples.

To design the drone display 215, the example drone display system 225 includes the drone display design system 240. As described herein, the example drone display design system 240 of FIG. 2 may use the inputs 245 provided by the user 235 to design the drone display 215 and to map content 250 onto the drone display 215. In this way, the drone display design system 240 assists the user 235 in the design of the drone display 215. In some examples, the drone display design system 240 uses optimization techniques to design the drone display 215.

In some examples, the drone display design system 240 stores the designed drone display 215 in a display definition datastore 255 ahead of the drone display 215 being activated. In some examples, the drone display 215 is designed in real time as the drone display 215 is being used. The design of the drone display 215 may be stored in the example display definition datastore 255 using any number and/or type(s) of data structures on any number and/or type(s) of computer-readable storage device or memory.

To activate (e.g., fly, begin displaying content, start, etc.) the example drone display 215, the example drone display system 225 includes an example flight system 260. In some cases, the example flight system 260 maps the content 250 (e.g., different lighting colors, lighting activation/deactivation, etc.) onto the drone display 215 specified by the display definition 255, and activates the drone display 215. In some examples, the drone display 215 being activated by the flight system 260 has been predetermined. In some examples, the drone display 215 may be designed prior to flying the drone display and stored for use in multiple shows, and in other examples the drone display 215 may be designed in real time by the drone display design system 240, with the flight system 260 activating the drone display 215 substantially as the drone display design system 240 designs the drone display 215. In some examples, the user 235 can control the activation of the drone display 215 via, for example, a user interface. The content 250 may be stored using any number and/or type(s) of data structures on any number and/or type(s) of computer-readable storage device or memory.

While an example manner of implementing the example drone display system 225 is illustrated in FIG. 2, one or more of the elements, processes or devices illustrated in FIG. 2 may be combined, divided, re-arranged, omitted, eliminated and/or implemented in any other way. Further, the example drone display design system 200 of FIG. 2 may include one or more elements, processes and/or devices in addition to, or instead of, those illustrated in FIG. 2, and/or may include more than one of any or all the illustrated elements, processes and devices.

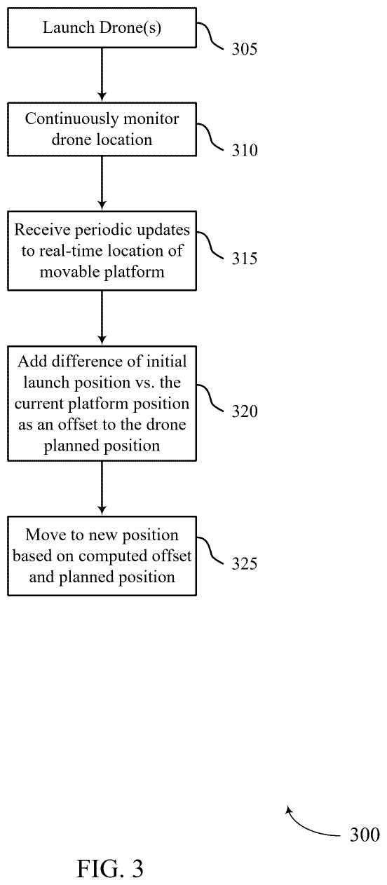

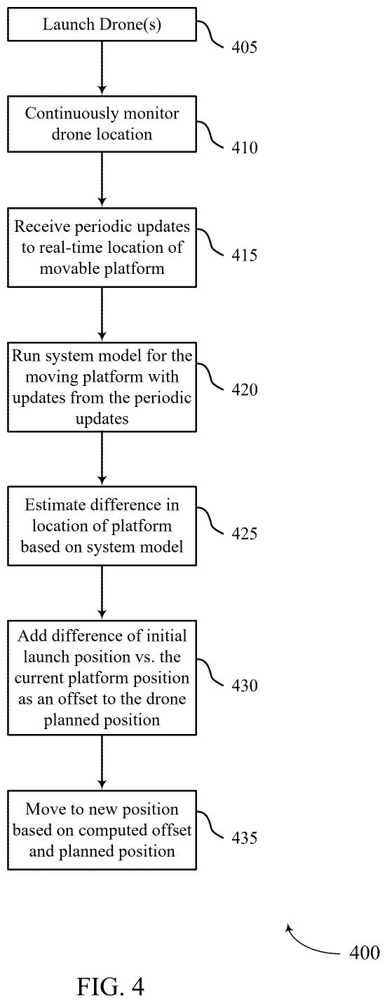

As discussed herein, in some aspects the drone display 215 may dynamically move to follow a direction of travel 265 of the movable platform 220, and may also adjust an orientation 270 based on movement of the movable platform 220 (e.g., an animation provided by the drone display 215 may rotate to face towards the audience as the movable platform 220 turns). Further, one or more drones 210 may launch from the moving platform 220, land on the moving platform 220, or both. For example, a set of drones 210 may take off from a moving area at a location (x) and land on a moving area, which may be the same area as launch or a different area, at a location (y), and location (y) is not predetermined prior to take off from location (x). In some examples, a positioning system 270, which may be included in drone display system 225 or separate from drone display system 225, may provide updates to a position of the moving platform 220 to the drones 210, which the drones 210 may use to adjust positioning of the drone display 215, to determine a landing location on the moving platform 220, or both. In other aspects, additionally or alternatively, the moving platform 220 may have its own systems that provide position and/or orientation information (e.g., from a GNSS system), and information from such systems may be provided for updates to the position and/or orientation of the moving platform. FIGS. 3 and 4 show exemplary operations for drone displays associated with a moving platform.

While an example manner of implementing the drone display is illustrated in FIG. 2, one or more of the elements, processes and/or devices illustrated in FIG. 2 may be combined, divided, re-arranged, omitted, eliminated or implemented in any other way. Further, aspects of drone display system 225 may be implemented by hardware, software, firmware and/or any combination of hardware, software and/or firmware. Thus, for example, any of the example drone display design system 240 content 250 storage, display definition 255 storage, or flight system 260 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the components is/are hereby expressly defined to include a non-transitory computer-readable storage device or storage disk such as a memory, a digital versatile disk (DVD), a compact disc (CD), a Blu-ray disk, etc. including the software and/or firmware. Further still, the example drone display system 225 of FIG. 2 may include one or more elements, processes and/or devices in addition to, or instead of, those illustrated in FIG. 2, and/or may include more than one of any or all the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

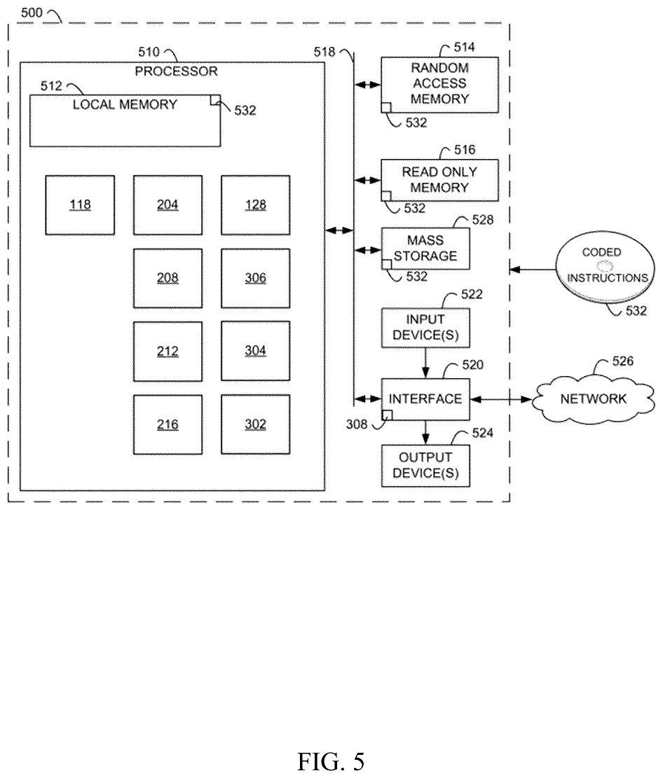

FIG. 3 is a flow chart diagram 300 illustrating an example implementation of a drone display. Aspects of FIG. 3 may be implemented by a drone display system, such as illustrated in FIG. 2 that deploys one or more drones such as illustrated in FIG. 1. The operations of flow chart diagram 300 may be implemented in hardware logic or machine-readable instructions for implementing the drone display. The machine-readable instructions may be a program or portion of a program for execution by a processor such as the processor 510 shown in the example processor platform 500 discussed below in connection with FIG. 5. The program may be embodied in software stored on a non-transitory computer-readable storage medium such as a compact disc read-only memory (CD-ROM), a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although exemplary operations are described with reference to FIG. 3, many other methods of implementing the example drone display may alternatively be used. For example, the order of execution of the blocks may be changed, or some of the blocks described may be changed, eliminated, or combined. Additionally, or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

In the example of FIG. 3, at 305, one or more drones may be launched. The one or more drones may be launched from a launch pad, for example, that houses the one or more drones. In some examples, the launch pad may be located on the moving platform. In other examples, the launch pad may be located on a different platform that is stationary or moving.

At 310, each of the drones may continuously monitor its location. In some examples, location monitoring may be performed using a GNSS system (e.g., using a GPS module). In other examples, additionally or alternatively, location monitoring may be performed using a terrestrial-based positioning system, such as one or more beacons that may be used to triangulate position relative to a fixed point that is defined by the system. Location monitoring may include monitoring of drone location in latitude, longitude, and altitude, or based on a geographic coordinate system (e.g., WGS84). In some examples, an orientation of the drone may also be monitored. In some examples, the drones may triangulate a current position based at least in part on one or more visual/optical beacons, radio beacons, or ultra sonic beacons, which may be all active or passive (e.g., that reflect an incoming signal or beam), or a combination thereof.

At 315, the one or more drones may receive periodic updates of a real-time location of the movable platform. In some examples, a drone display system on the movable platform may continuously monitor a location of the platform (e.g., one location measurement per second or one location measurement per five seconds) and transmit the periodic updates (e.g., one update every one second or every five seconds) of the real-time platform location to the one or more drones. In some examples, the updates of the real-time location of the movable platform may be transmitted using a cellular connection, a Wi-Fi connection, or other radio frequency link between the drone display system and the one or more drones. In other examples, additionally or alternatively, communications between the drone display system and the one or more drones may be via optical communications, or via wired communications to a tethered drone. In further examples, one or more drones may relay received updates to one or more other drones (e.g., to provide redundancy in communications).

At 320, the one or more drones may add a difference of the initial launch field position versus the current position of the movable platform as an offset to the planned position of the drone (e.g., as provided by the drone display system). In some examples, positioning may be absolute positioning that may be determined using one or more of tracking a mobile platform pose, using one or more real-time kinematics (RTK) GPS/GNSS units and a compass sensor, using one or more RTK GPS/GNSS units and a system model to determine orientation (e.g., a moving boat is assumed to be aligned in the direction of travel), using at least two RTK GPS/GNSS units, using other types of satellite based positioning, using other one or more naval positioning systems (e.g., ship radar, etc.), tracking a pose of the drone, or any combinations thereof. In other examples, positioning may be relative positioning that is relative to the moving platform, and may be determined using one or more of visual tracking, such as using one or more cameras on the moving platform that track relative drone positions and provide information to the one or more drones (e.g., using active markers or passive markers on drones, using drone outlines, using drone animation lights, or any combinations thereof), using one or more cameras on one or more drones that track the moving platform (e.g., using active markers or passive markers on the moving platform, using an outline of moving platform, or any combinations thereof), using radio beacons (e.g., Ultra Wide Band (UWB), single frequency time-of-flight measurements, dual-band/multi-band time-of-flight measurements, or any combinations thereof), cross-bearing using base stations on the moving platform with rotating laser beam fans and one or multiple light detectors on board the drones, cross-bearing using antenna arrays (UWB or single/multi band), or any combinations thereof.

At 325, the one or more drones may move to a new position based on the computed offset and a planned position. In some examples, the planned position may be a pre-planned position based on designed movements of the display, and the new position may account for movement of the moving platform to adjust the pre-planned position achieve the desired display (e.g., in relation to one or more other drones). In some cases, drone positions may be based on a static animation (e.g., a screen) that is planned and movement of the static animation (e.g., screen) is due to real-time adjustments for position and/or orientation of the moving platform. In some other cases, all drone movement may be pre-planned based on planned movement of the platform (e.g., stage elements may move during a show and drones flying above those stage elements may move based on the pre-planned stage element movement). For example, a band car at a venue may move according to a planned path as part of a performance, and a drone display associated with the car may move along with the car in accordance with the planned path, with either no real-time adjustments or real-time adjustments for any differences in planning versus reality during show execution.

In some examples, a display provided by the one or more drones may also adjust positions of the one or more drones to account for a changing orientation of the moving platform in addition to position tracking, so that the display remains facing an audience as intended. For example, a ship may make a turn, and the provided display may rotate to remain facing the audience. In another example, the moving platform may be part of a parade or procession and make a turn on a street, and the provided display may rotate to remain facing an audience on sides of the street that are viewing the display. In some examples, the one or more drones may land based on the new position, which corresponds to a position of a landing area for the one or more drones (e.g., that may be located on the moving platform).

FIG. 4 is a flow chart diagram 400 illustrating another example implementation of a drone display. Aspects of FIG. 4 may be implemented by a drone display system, such as illustrated in FIG. 2 that deploys one or more drones such as illustrated in FIG. 1. The operations of flow chart diagram 400 may be implemented in hardware logic or machine-readable instructions for implementing the drone display. The machine-readable instructions may be a program or portion of a program for execution by a processor such as the processor 510 shown in the example processor platform 500 discussed below in connection with FIG. 5. The program may be embodied in software stored on a non-transitory computer-readable storage medium such as a compact disc read-only memory (CD-ROM), a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although exemplary operations are described with reference to FIG. 4, many other methods of implementing the example drone display may alternatively be used. For example, the order of execution of the blocks may be changed, or some of the blocks described may be changed, eliminated, or combined. Additionally, or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

In the example of FIG. 4, at 405, one or more drones may be launched. The one or more drones may be launched from a launch pad, for example, that houses the one or more drones. In some examples, the launch pad may be located on the moving platform. In other examples, the launch pad may be located on a different platform that is stationary or moving.

At 410, each of the drones may continuously monitor its location. In some examples, location monitoring may be performed using a GNSS system (e.g., using a GPS module). In other examples, additionally or alternatively, location monitoring may be performed using a terrestrial-based positioning system, such as one or more beacons that may be used to triangulate position relative to a fixed point that is defined by the system. Location monitoring may include monitoring of drone location in latitude, longitude, and altitude, or based on a geographic coordinate system (e.g., WGS84). In some examples, an orientation of the drone may also be monitored.

At 415, the one or more drones may receive periodic updates of a real-time location of the movable platform. In some examples, a drone display system on the movable platform may continuously monitor a location of the platform (e.g., one location measurement per second or one location measurement per five seconds) and transmit the periodic updates (e.g., one update every one second or every five seconds) of the real-time platform location to the one or more drones. In some examples, the updates of the real-time location of the movable platform may be transmitted using a cellular connection, a Wi-Fi connection, or other radio frequency link between the drone display system and the one or more drones. In other examples, additionally or alternatively, communications between the drone display system and the one or more drones may be via optical communications, or via wired communications to a tethered drone. In further examples, one or more drones may relay received updates to one or more other drones (e.g., to provide redundancy in communications).

At 420, the one or more drones may run a system model for the moving platform with updates from the periodic updates. In some examples, the system model may be updated continuously with the latest position measurements of the moving platform coming in over radio (or other communications medium). In some examples, the system model may include a Kalman filter, and each update may be provided to the filter, with an output of the filter providing an estimated updated position of the moving platform. In such examples, intermittent radio packet loss may be mitigated and even in case of a complete radio loss the one or more drones may be able to estimate the movement of the moving platform, maintain the display, and estimate a landing location (e.g., if on the moving platform) with sufficient accuracy to provide a high likelihood of a successful landing.

At 425, the one or more drones may estimate a difference in the location of the moving platform based on the received updates and the system model. At 430, the one or more drones may add a difference of the initial launch position versus the current position of the movable platform as an offset to the planned position of the drone (e.g., as provided by the drone display system). In some examples, as discussed with reference to FIG. 3, positioning may be absolute positioning or relative positioning that may be determined as discussed herein.

At 435, the one or more drones may move to a new position based on the computed offset and a planned position. In some examples, the planned position may be a pre-planned position based on designed movements of the display, and the new position may account for movement of the moving platform to adjust the pre-planned position achieve the desired display (e.g., in relation to one or more other drones). In some examples, a display provided by the one or more drones may also adjust positions of the one or more drones to account for a changing orientation of the moving platform in addition to position tracking, so that the display remains facing an audience as intended. For example, a ship may make a turn, and the provided display may rotate to remain facing the audience. In another example, the moving platform may be part of a parade or procession and make a turn on a street, and the provided display may rotate to remain facing an audience on sides of the street that are viewing the display. In some examples, the one or more drones may land based on the new position, which corresponds to a position of a landing area for the one or more drones (e.g., that may be located on the moving platform).

As mentioned above, the example processes of FIGS. 3 and 4 may be implemented using executable instructions (e.g., computer and/or machine-readable instructions) stored on a non-transitory computer and/or machine-readable medium such as a hard disk drive, a flash memory, a read-only memory, a CD-ROM, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer-readable storage device and/or storage disk and to exclude propagating signals and to exclude transmission media.

FIG. 5 is a block diagram of an example processor platform 500 structured to execute the instructions and to implement drone displays as discussed herein. The processor platform 500 can be, for example, a server, a personal computer, a workstation, a mobile device (e.g., a cell phone, a smart phone, a tablet such as an IPAD™), or any other type of computing device.

The processor platform 500 of the illustrated example includes a processor 510. The processor 510 of the illustrated example is hardware. For example, the processor 510 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example drone display design system 240, the example flight system 260, content 250 storage, display definition 255 storage, or any combinations thereof.

The processor 510 of the illustrated example includes a local memory 512 (e.g., a cache). The processor 510 of the illustrated example is in communication with a main memory including a volatile memory 514 and a non-volatile memory 516 via a bus 518. The volatile memory 514 may be implemented by Synchronous Dynamic Random-Access Memory (SDRAM), Dynamic Random-Access Memory (DRAM), and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface. In the illustrated example, the interface circuit 520 implements the example flight system.

In the illustrated example, one or more input devices 522 are connected to the interface circuit 520. The input device(s) 522 permit(s) a user to enter data and/or commands into the processor 510. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, solid state drives, CD drives, Blu-ray disk drives, redundant array of independent disks (RAID) systems, and DVD drives.

Coded instructions 532 including the coded instructions of FIG. 4 may be stored in the mass storage device 528, in the volatile memory 514, in the non-volatile memory 516, and/or on a removable non-transitory computer-readable storage medium such as a CD-ROM or a DVD.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The following provides an overview of aspects of the present disclosure:

Aspect 1: A method for adjusting a flight path at a drone, comprising: launching the drone from a first location in accordance with an initial flight path that provides for movement of the drone relative to a viewing area; monitoring a current location of the drone relative to the initial flight path while following the initial flight path to provide a portion of a visual display formed with a plurality of other drones; receiving an update to a real-time location of one or more of the viewing area or the first location; modifying the initial flight path based at least in part on the update to the real-time location to generate a modified flight path; and following the modified flight path while continuing to provide the portion of a visual display.

Aspect 2: The method of aspect 1, further comprising: determining a landing location based at least in part on the modified flight path and one or more additional updates to the real-time location of one or more of the viewing area or the first location; and landing at the landing location.

Aspect 3: The method of any of aspects 1 through 2, wherein the modifying the initial flight path comprises: providing the update to the real-time location of one or more of the viewing area or the first location to a Kalman filter; obtaining, from the Kalman filter, an estimated current position of the one or more of the viewing area or the first location; and determining a difference between the estimated current position and a corresponding planned position from the initial flight path; and modifying the initial flight path to provide an offset to remaining planned positions from the initial flight path to generate the modified flight path.

Aspect 4: The method of any of aspects 1 through 3, wherein the first location is on a moving platform, the viewing area is a moving viewing area, a landing location is on the moving platform, or any combinations thereof.

Aspect 5: The method of any of aspects 1 through 4, wherein the initial flight path includes a landing location that is associated with the first location or the viewing area, and wherein a modified landing location is unknown at the launch of the drone from the first location.

Aspect 6: The method of aspect 5, wherein the first location and the landing location are a same area on a moving platform.

Aspect 7: The method of any of aspects 1 through 6, wherein the first location is a stationary location away from the viewing area, and an initial position of the viewing area corresponds to a position of the viewing area when the drone launches, and a landing location of the drone is at a second location away from the viewing area.

Aspect 8: A drone for adjusting a flight path, comprising one or more memories storing processor-executable code, and one or more processors coupled with the one or more memories and individually or collectively operable to execute the code to cause the drone to perform a method of any of aspects 1 through 7.

Aspect 9: A drone for adjusting a flight path, comprising at least one means for performing a method of any of aspects 1 through 7.

Aspect 10: A non-transitory computer-readable medium storing code for adjusting a flight path, the code comprising instructions executable by one or more processors to perform a method of any of aspects 1 through 7.

Aspect 11: A drone apparatus, comprising: a vehicle drive component comprising at least one drive motor and at least one propeller coupled with the at least one drive motor, the vehicle drive component configured to enable flight and control for the drone; one or more processors configured to control the vehicle drive component to fly the drone on a flight path; and a position monitor configured to monitor a position of the drone and a moving platform position, wherein the one or more processors are configured to adjust the flight path of the drone based at least in part on a movement of the moving platform by adding a difference of an initial position of the moving platform and a current position of the moving platform to a planned drone position according to the flight path.

Aspect 12: The drone apparatus of aspect 5, further comprising a radio communications component configured to receive one or more updates to the moving platform position.

Aspect 13: The drone apparatus of aspect 12, wherein the one or more processors are further configured to run a system model for the moving platform that is updated based at least in part on the one or more updates to the moving platform position and outputs an estimated position of the moving platform, and wherein the flight path of the drone is further adjusted based at least in part on the estimated position of the moving platform.

Aspect 14: The drone apparatus of aspect 13, wherein the system model includes a Kalman filter that receives the one or more updates to the moving platform position and outputs the estimated position of the moving platform.

Aspect 15: The drone apparatus of any of aspects 12 through 4, wherein the drone is configured to launch from a first area on the moving platform, and wherein the initial position of the moving platform corresponds to a position of the first area when the drone launches.

Aspect 16: The drone apparatus of aspect 15, wherein the drone is configured to land at a second area on the moving platform subsequent to a flight according to the flight path, and wherein a subsequent position of the second area on the moving platform is unknown at the launch of the drone from the first area.

Aspect 17: The drone apparatus of aspect 16, wherein the first area and the second area are a same area on the moving platform.

Aspect 18: The drone apparatus of any of aspects 12 through 17, wherein: the drone is configured to launch from a first area that is a stationary area away from the moving platform, and wherein the initial position of the moving platform corresponds to a position of the moving platform when the drone launches.

Aspect 19: The drone apparatus of aspect 18, wherein the drone is configured to land at a second area that is a stationary area away from the moving platform subsequent to a flight according to the flight path.

Aspect 20: The drone apparatus of aspect 19, wherein the first area and the second area are a same area.

Aspect 21: The drone apparatus of any of aspects 12 through 20, wherein the drone is configured to launch from a first area that is a moving area on the moving platform, and wherein the initial position of the moving platform corresponds to a position of the moving platform when the drone launches.

Aspect 22: The drone apparatus of aspect 21, wherein the drone is configured to land at a second area that is a different moving area away on a different moving platform subsequent to a flight according to the flight path.

Aspect 23: A system for a visual drone display, comprising: a plurality of drones; a flight system that provides a drone flight path to each drone of the plurality of drones; and a position monitoring system located on a moving platform that provides periodic position updates of the moving platform to the plurality of drones, wherein the plurality of drones are configured to launch from the moving platform while at a first location and to land on the moving platform while at a second location that is different than the first location and is unknown prior to the launch from the moving platform.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B with C.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A drone apparatus, comprising:
a vehicle drive component comprising at least one drive motor and at least one propeller coupled with the at least one drive motor, the vehicle drive component configured to enable flight and control for the drone;
one or more processors configured to control the vehicle drive component to fly the drone on a flight path; and
a position monitor configured to monitor a position of the drone and a moving platform position, wherein the one or more processors are configured to adjust the flight path of the drone based at least in part on a movement of the moving platform by adding a difference of an initial position of the moving platform and a current position of the moving platform to a planned drone position according to the flight path.

2. The drone apparatus of claim 1, further comprising:
a radio communications component configured to receive one or more updates to the moving platform position.

3. The drone apparatus of claim 2, wherein:
the one or more processors are further configured to run a system model for the moving platform that is updated based at least in part on the one or more updates to the moving platform position and outputs an estimated position of the moving platform, and wherein the flight path of the drone is further adjusted based at least in part on the estimated position of the moving platform.

4. The drone apparatus of claim 3, wherein:
the system model includes a Kalman filter that receives the one or more updates to the moving platform position and outputs the estimated position of the moving platform.

5. The drone apparatus of claim 1, wherein:
the drone is configured to launch from a first area on the moving platform, and wherein the initial position of the moving platform corresponds to a position of the first area when the drone launches.

6. The drone apparatus of claim 5, wherein:
the drone is configured to land at a second area on the moving platform subsequent to a flight according to the flight path, and wherein a subsequent position of the second area on the moving platform is unknown at the launch of the drone from the first area.

7. The drone apparatus of claim 6, wherein:
the first area and the second area are a same area on the moving platform.

8. The drone apparatus of claim 1, wherein:
the drone is configured to launch from a first area that is a stationary area away from the moving platform, and wherein the initial position of the moving platform corresponds to a position of the moving platform when the drone launches.

9. The drone apparatus of claim 8, wherein:
the drone is configured to land at a second area that is a stationary area away from the moving platform subsequent to a flight according to the flight path.

10. The drone apparatus of claim 9, wherein:
the first area and the second area are a same area.

11. The drone apparatus of claim 1, wherein:
the drone is configured to launch from a first area that is a moving area on the moving platform, and wherein the initial position of the moving platform corresponds to a position of the moving platform when the drone launches.

12. The drone apparatus of claim 11, wherein:
the drone is configured to land at a second area that is a different moving area away on a different moving platform subsequent to a flight according to the flight path.

13. A system for a visual drone display, comprising:
a plurality of drones;
a flight system that provides a drone flight path to each drone of the plurality of drones; and
a position monitoring system located on a moving platform that provides periodic position updates of the moving platform to the plurality of drones, wherein the plurality of drones are configured to launch from the moving platform while at a first location and to land on the moving platform while at a second location that is different than the first location and is unknown prior to the launch from the moving platform.

14. A method for adjusting a flight path at a drone, comprising:
launching the drone from a first location in accordance with an initial flight path that provides for movement of the drone relative to a viewing area;
monitoring a current location of the drone relative to the initial flight path while following the initial flight path to provide a portion of a visual display formed with a plurality of other drones;
receiving an update to a real-time location of one or more of the viewing area or the first location;
modifying the initial flight path based at least in part on the update to the real-time location to generate a modified flight path; and
following the modified flight path while continuing to provide the portion of a visual display.

15. The method of claim 14, further comprising:
determining a landing location based at least in part on the modified flight path and one or more additional updates to the real-time location of one or more of the viewing area or the first location; and
landing at the landing location.

16. The method of claim 14, wherein the modifying the initial flight path comprises:
providing the update to the real-time location of one or more of the viewing area or the first location to a Kalman filter;
obtaining, from the Kalman filter, an estimated current position of the one or more of the viewing area or the first location; and
determining a difference between the estimated current position and a corresponding planned position from the initial flight path; and
modifying the initial flight path to provide an offset to remaining planned positions from the initial flight path to generate the modified flight path.

17. The method of claim 14, wherein:
the first location is on a moving platform, the viewing area is a moving viewing area, a landing location is on the moving platform, or any combinations thereof.

18. The method of claim 14, wherein:
the initial flight path includes a landing location that is associated with the first location or the viewing area, and wherein a modified landing location is unknown at the launch of the drone from the first location.

19. The method of claim 18, wherein:
the first location and the landing location are a same area on a moving platform.

20. The method of claim 14, wherein:
the first location is a stationary location away from the viewing area, and an initial position of the viewing area corresponds to a position of the viewing area when the drone launches, and a landing location of the drone is at a second location away from the viewing area.
